(19) United States
(12) Patent Application Publication
(10) Pub. No.: US 2006/0149815 A1
(43) Pub. Date: Jul. 6, 2006

(54) Managing participants in an integrated web/audio conference

(76) Inventors: Sean Spradling, Monument, CO (US); Kim Kokkonen, Colorado Springs, CO (US); Randolph Leigh, Monument, CO (US); Laurence Schaefer, Colorado Springs, CO (US)

Correspondence Address: SMITH FROHWEIN TEMPEL GREENLEE BLAHA, LLC, P.O. BOX 88148, ATLANTA, GA, 30356, US

(21) Appl. No.: 11/026,200

(22) Filed: Dec. 30, 2004

(51) Int. Cl. G06F 15/16

(52) U.S. Cl. 709/205

(57) ABSTRACT

Various embodiments of systems, methods, computer programs, etc. for managing participants in an integrated web/audio conference system are provided. One embodiment is a method for managing participants in an integrated web/audio conference system comprising: merging one of an audio participant and a web participant of an integrated web/audio conference with the other of the audio participant and the web participant in a console view of the integrated web/audio conference.

### BACKGROUND

Currently, there are various web conference systems that enable individuals, employees, etc. to collaborate via a data communications network. In general, web conferencing combines the convenience of audio conferencing with the collaborative qualities of the Web (or any data communications system). Web conferencing enables participants to easily join the web portion of the conference, the audio portion of the conference, or both. Typically, web conferencing systems include a web-based visual component for conveniently sharing the presentation materials across the data communications network. When using existing web conferencing systems, however, it can be very difficult to determine the identity of attendees.

### SUMMARY

Various embodiments of systems, methods, computer programs, etc. for managing participants in an integrated web/audio conference system are provided. One embodiment is a method for managing participants in an integrated web/audio conference system comprising: merging one of an audio participant and a web participant of an integrated web/audio conference with the other of the audio participant and the web participant in a console view of the integrated web/audio conference.

Another embodiment is a web conference system. One such system comprises: a conference manager that monitors audio and web attendees participating in an integrated audio/web conference; a console for displaying the audio and web attendees participating in the integrated audio/web conference; and an attendee merge functionality associated with the console, the attendee merge functionality comprising logic configured to merge one of the audio participants with one of the web participants in the console.

### BRIEF DESCRIPTION OF THE DRAWINGS

Other aspects, advantages and novel features of the invention will become more apparent from the following detailed description of exemplary embodiments of the invention when considered in conjunction with the following drawings.

FIG. 1 is a block diagram of one of a number of embodiments of a conference platform that provides integrated audio/web conferencing services.

FIG. 2 is a block diagram illustrating an embodiment of the conference platform of FIG. 1.

FIG. 3 is a flow chart illustrating the general operation of the conference platform of FIGS. 1 & 2.

FIG. 4 illustrates an embodiment of a moderator console and an attendee console supported by the conference platform of FIGS. 1 and 2.

FIG. 5 is a block diagram illustrating an embodiment of the web/audio conference manager of the conference platform of FIGS. 1 and 2.

FIG. 6 is a flow chart illustrating the architecture, operation, and/or functionality of an embodiment of the attendee merge system of FIG. 5.

FIG. 7 is a user interface view of an embodiment of a moderator console.

FIG. 8 illustrates the moderator console of FIG. 7 after a web attendee joins the conference.

FIG. 9 is a flow chart illustrating an embodiment of a method by which a web attendee may join a conference supported by the conference platform of FIGS. 1 & 2.

FIG. 10 is a flow chart illustrating the architecture, operation, and/or functionality of another embodiment of the attendee merge system of FIG. 5.

FIG. 11 illustrates the moderator console of FIG. 8 after a new audio attendee joins the conference.

FIG. 12 illustrates the moderator console of FIG. 8 after one of the existing web attendees joins the conference.

FIG. 13 illustrates the moderator console of FIG. 8 after a new web attendee joins the conference.

FIG. 14 illustrates another embodiment of an exemplary moderator console.

FIG. 15 illustrates the moderator console of FIG. 14 when “Dial-In Participant 1” is speaking.

FIG. 16 illustrates an embodiment of a “Merge Participant” window initiated when the “Merge” button is selected for “Dial-In Participant 1.”

FIG. 17 illustrates the “Merge Participant” window of FIG. 16 in which Attendee 1 has been selected.

FIG. 18 illustrates the moderator console of FIG. 15 after the merge process is completed.

FIG. 19 is a flow chart illustrating the architecture, operation, and/or functionality of another embodiment of the attendee merge system of FIG. 5.

FIG. 20 is a block diagram of another embodiment of a conference platform that provides integrated audio/web conferencing services.

### DETAILED DESCRIPTION

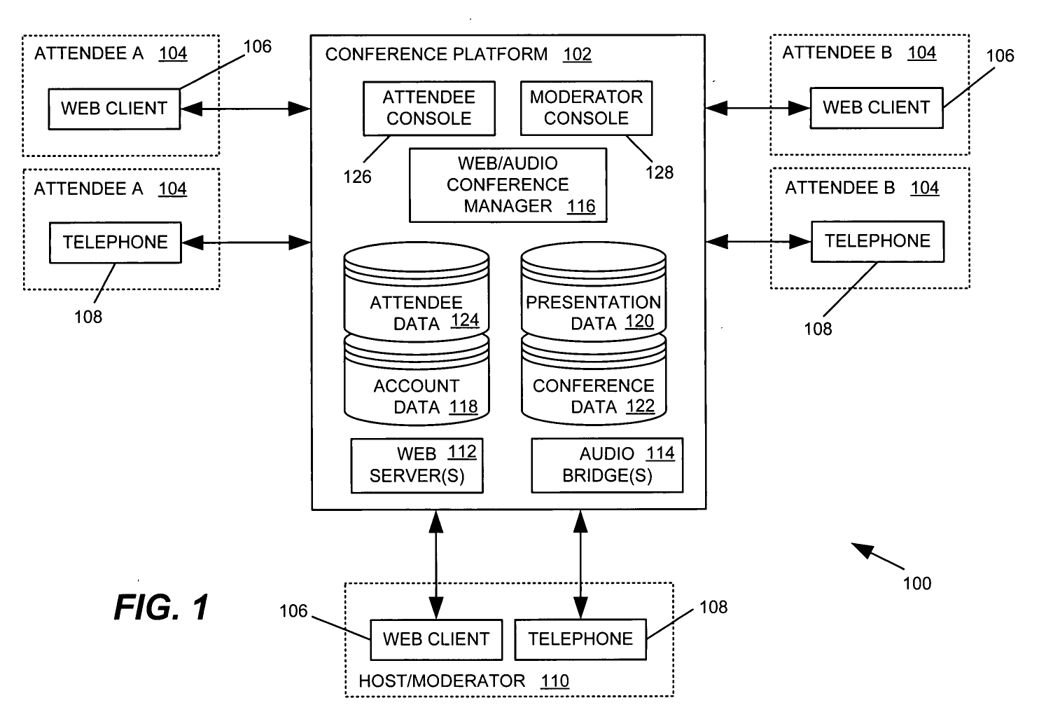

Various embodiments of systems, methods, computer programs, etc. for managing participants in an integrated web/audio conference are provided. Several embodiments are described below with reference to FIGS. 1-20. As an introductory matter, however, the general operation of an exemplary embodiment of an attendee merge system (AMS) will be briefly described. The exemplary AMS is implemented in an integrated web/audio conference system. As mentioned above, an integrated web/audio conference system provides a web conferencing component and an audio conferencing component. The web conferencing component comprises a visual web component for participants or attendees of the conference, while the audio component manages audio calls for the attendees (e.g., dial-in or dial-out calls via the PSTN, Internet, etc.).

In conjunction with the web component, the integrated web/audio conference system may also provide a console view of the active participants or attendees in the conference. The console view may display web attendees and audio attendees as they join the conference. The console view may also display various types of information about the web and audio attendees. For example, the console view may display the name of each web attendee, identify the role of the web attendee (e.g., host, moderator, participant, etc.), and identify audio attendees (e.g., by name, telephone number, etc.), as well as provide a means for merging a web-only attendee with one of the audio-only attendees (and vice versa).

In this regard, the exemplary AMS comprises the means, logic, functionality, etc. for merging audio and web attendees in the console view. By way of example, when a web attendee joins the conference, his/her name may be displayed in the console view along with information indicating that the attendee is a web attendee. When the same individual joins the audio portion of the conference, the AMS provides the mechanism for merging the audio attendee with the appropriate web attendee in the console view, rather than displaying separate audio and web attendees. In other words, the AMS provides the logic, functionality, etc. for determining that a web attendee and an audio attendee should be associated with the same person. The AMS may also control the visual merging of the two attendees in the console view as a single “conference attendee.”

As described in more detail below, the AMS may merge an audio-only participant with a web-only participate (and vice versa) in the console view in a number of ways. In one embodiment, the AMS may support a user interface functionality that enables a web attendee (e.g., a web moderator) to manually perform the merge via the console view. For example, one of the existing audio-only attendees may be selected via the user interface. The identity of the audio-only attendee may be confirmed via the audio portion of the conference. In some embodiments, the console view may visually indicate when an audio attendee is speaking and, therefore, an individual may determine the identity of the audio attendee. After the audio-only attendee is selected, the AMS may display a list of existing web-only attendees to which the selected audio-only attendee may be merged. The appropriate web-only attendee may be selected who matches the identity of the audio-only attendee. When the pair of attendees have been identified and associated with each other, the AMS may merge the attendees in the console view. The user interface may also enable the “unmerging” of merged attendees.

In another embodiment, the AMS may automatically merge web and audio participants based on attendee-related data stored by a conference platform. For instance, when an individual joins the web portion of the conference (or registers with the conference platform or otherwise associates with the conference platform), various forms of attendee-related information may be obtained by the conference platform (e.g., email address, telephone number, name, etc.). Furthermore, the conference platform may assign unique information to an individual, such as a passcode, PIN, or user account, to name a few—which may also be stored by the conference platform and used to identify the individual. Any of these types of information may be stored by the conference platform and associated with a particular individual. When an individual joins the web portion of the conference or the audio portion of the conference, the AMS may capture, receive, obtain, etc. the attendee-related information. The AMS may use this information to automatically match an audio attendee to a web attendee (and vice versa) and then merge the respective attendees in the console view.

In another embodiment, the AMS may automatically merge an audio attendee to a web attendee based on the originating telephone number, IP address, etc. of the audio attendee. When the audio attendee places a call to join the audio portion of the conference, the conference platform may automatically obtain the originating telephone number using an automatic number identification (ANI) service supported by the local telephone service provider. If the audio call is being established via a voice-over-Internet (VOI) protocol (e.g., via VoIP, VoDSL, VoATM, etc.), the conference platform may similarly obtain the identifying address of the endpoint. The AMS may search to determine if any existing web attendees have attendee-related data that matches the telephone number, IP address, etc. for the audio attendee. If there is a match, the AMS may automatically merge the audio and web attendees in the console view.

Having described the general operation of one possible embodiment of an attendee merge system for an integrated web/audio conference, various additional embodiments of systems, methods, computer programs, etc. for managing participants in an integrated web/audio conference will be described with reference to FIGS. 1-20.

FIG. 1 illustrates an integrated web/audio conference system (IWACS) 100 in which an attendee merge system (AMS) may be employed. Various embodiments of an AMS are described below in more detail. As illustrated in FIG. 1, however, IWACS 100 comprises a conference platform 102 that provides integrated web/audio conference services to attendee(s) 104. Attendees 104 may access the web portion of the conference using a web client 106 that communicates with web server(s) 112. Attendees 104 may access the audio portion of the conference using a telephone 108 (e.g., PSTN phone, mobile phone, voice-over-Internet (VOI) telephone, etc.). Conference platform 102 may employ an audio bridge 114 to manage all of the audio calls with attendees 104 into the teleconference.

As illustrated in FIG. 1, one of the attendee(s) 104 (i.e., host/moderator 110) may assume the role of host or moderator of the teleconference. Host/moderator 110 may access conference platform 102 via web client 106 and interact with web server(s) 112 to, for example, create a conference, upload a presentation, invite attendee(s) 104, and start the conference.

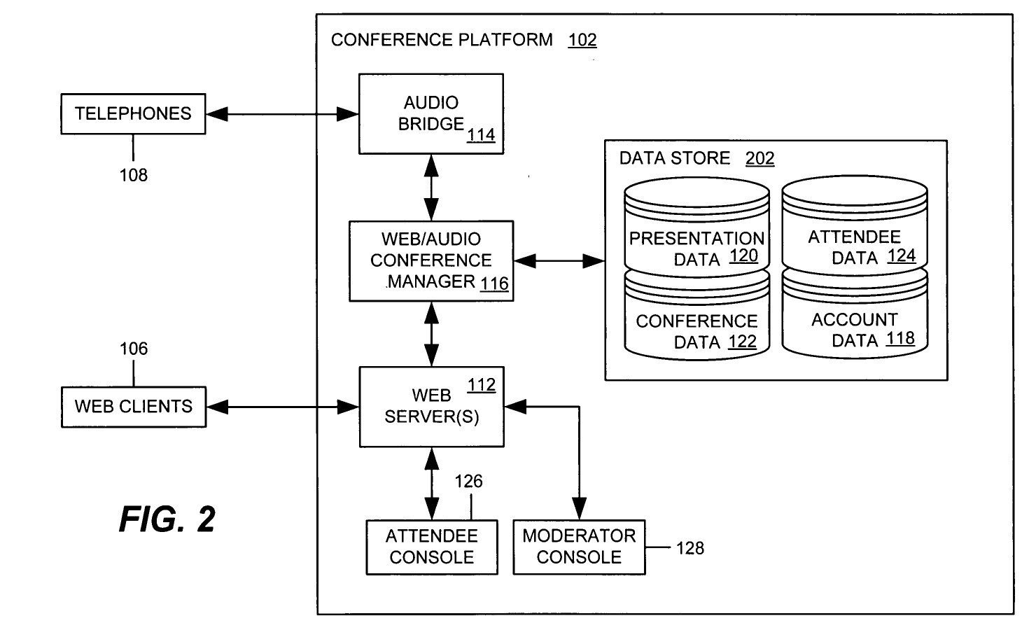

Conference platform 102 may include a data store 202 (FIG. 2) for storing various relevant information. For instance, conference data 122 may be used to store information regarding scheduled conferences (e.g., date, time, attendees, topic, dial-in number(s), passcode, etc.). It should be appreciated, however, that conference platform 102 may support real-time (or non-scheduled) conferences. In other words, in some embodiments, the conference may not necessarily need to be scheduled. Rather, the conference may be run at any time. Presentation data 120 may be used to store the presentation materials for scheduled conferences, which may include any audio and/or visual materials in any suitable format. Account data 118 may be used to store information regarding registered/authorized users, and attendee data 124 may be used to store information related to attendees 104 who access the conference platform via a web client 106 (i.e., web attendee/participant) and/or via a telephone 108 (i.e., audio attendee/participant).

As further illustrated in FIGS. 1 & 2, conference platform 102 also comprises a web/audio conference manager 116, an attendee console 126, and a moderator console 128. Web/audio conference manager 116 integrates the audio portion of the conference (audio bridge 114) with the web portion (web server(s) 112). Consoles 126 and 128 provide the user interfaces through which attendee(s) 104 and host/moderator 110, respectively, view the presentation materials associated with the web portion of the conference.

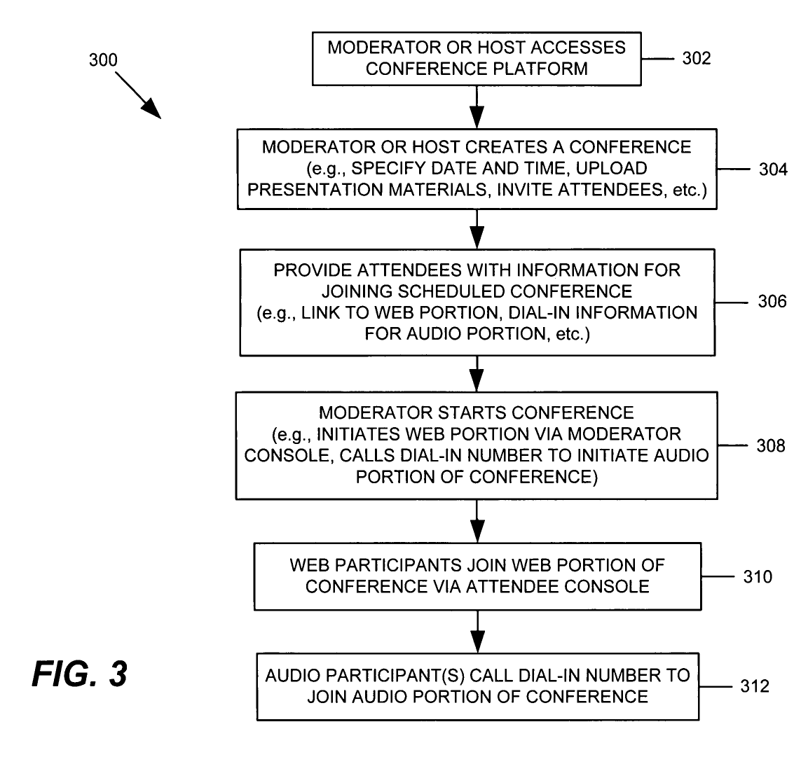

In order to further illustrate the general principles of IWACS 100 and the operation of conference platform 102, reference will be made to the flow chart of FIG. 3. At block 302, host/moderator 110 accesses conference platform 102 via web client 106 to create a conference. At block 304, host/moderator 110 may specify the date, time, etc. of the conference, and upload the presentation materials to be used during the conference. Host/moderator 110 may also identify and invite attendees to participate in the conference. At block 306, conference platform 102 may notify the invited attendees that a conference has been scheduled and that they have been invited. In one embodiment, conference platform 102 notifies the invited attendees via email, which may include a link for accessing the web portion of the conference, dial-in information for joining the audio portion of the conference, authentication passcode for security purposes, etc.

At the scheduled time, host/moderator 110 may start the scheduled conference (block 308). Host/moderator 110 may initiate the web portion of the conference via moderator console 128. The audio portion of the conference may be initiated when the host/moderator calls the designated dial-in number assigned to the conference. At block 310, attendee(s) 104 may join the web portion of the conference via attendee console 126. At block 312, attendee(s) may join the audio portion by calling the designated call-in number that terminates at conference platform 102.

As mentioned above, in some embodiments, conference platform 102 supports real-time (or non-scheduled) conferences, which may be run at any time. It should be appreciated that in these embodiments host/moderator 110 starts the conference without actually scheduling the conference.

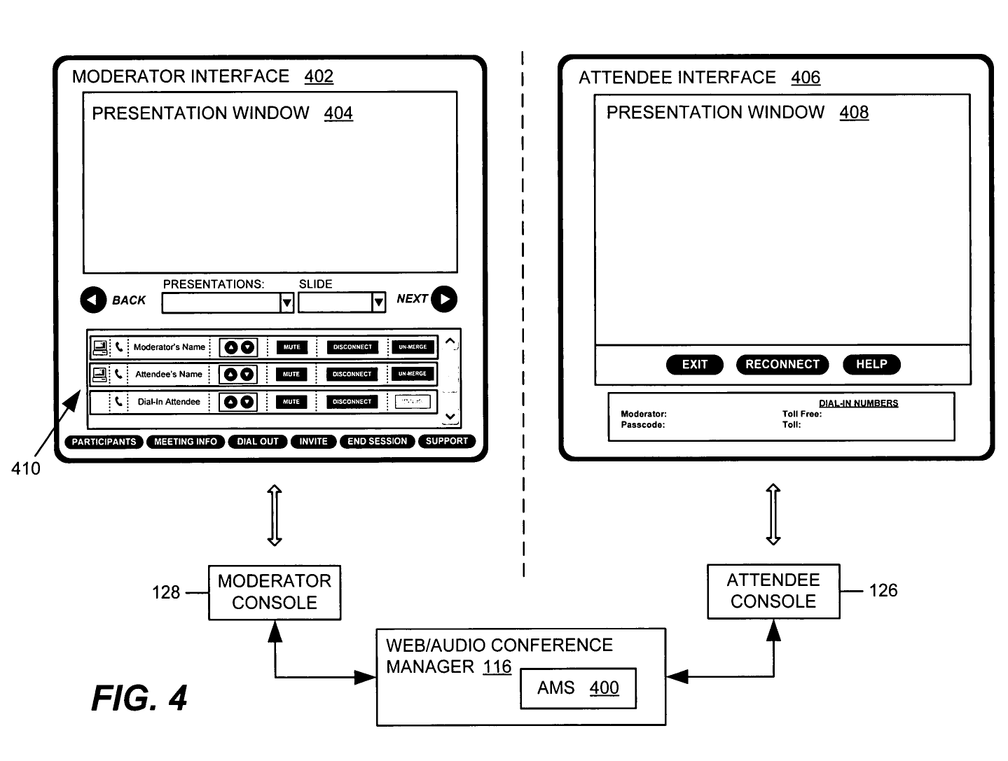

FIG. 4 illustrates an embodiment of a moderator console 128 and an attendee console 126. As illustrated in this embodiment, each console may include a presentation window for displaying the presentation material(s) for the conference. Moderator console 128 may also include user interface controls that enable host/moderator 110 to interact with the presentation materials. For example, where the presentation materials comprise a typical presentation, document, etc., moderator console 128 may be configured with controls to enable host/moderator 110 to navigate from page to page in the presentation or to go directly to a particular page via a page drop-down menu. One of ordinary skill in the art will appreciate that, as the display of the presentation materials in presentation window 404 of moderator consoler 128 are changed, web/audio conference manager 116 replicates the changes in presentation 408 of attendee console 126.

In addition to presentation window 408, attendee console 126 may also display relevant information regarding the audio portion of the teleconference (e.g., host/moderator name, passcode, dial-in number(s), etc.) to assist attendee(s) 104 that desire to join the audio portion of the conference, as well.

As further illustrated in FIG. 4, the visual real estate of moderator console 128 also includes a portion for displaying a participants view 410 of the conference. Participants view 410 displays all attendee(s) 104 that have joined the conference as a web participant and/or an audio participant. In this regard, participants view 410 may be configured with appropriate visual graphics, icons, etc. to indicate whether an attendee 104 is a web participant, an audio participant, or both. Participants view 410 may also display information identifying attendee(s) 104 or other desirable attendee-related data.

Referring again to FIG. 4, web/audio conference manager 116 may also comprise an attendee merge system (AMS) 400. As mentioned above, in general, AMS 400 comprises the logic, functionality, etc. associated with moderator console 128 for merging a web-only attendee with one of the audio-only attendees (and vice versa). In other words, AMS 400 is configured to determine that a web attendee and an audio attendee should be associated with the same person. AMS 400 may also control the visual merging of the two attendees in a console view (e.g., moderator console 128).

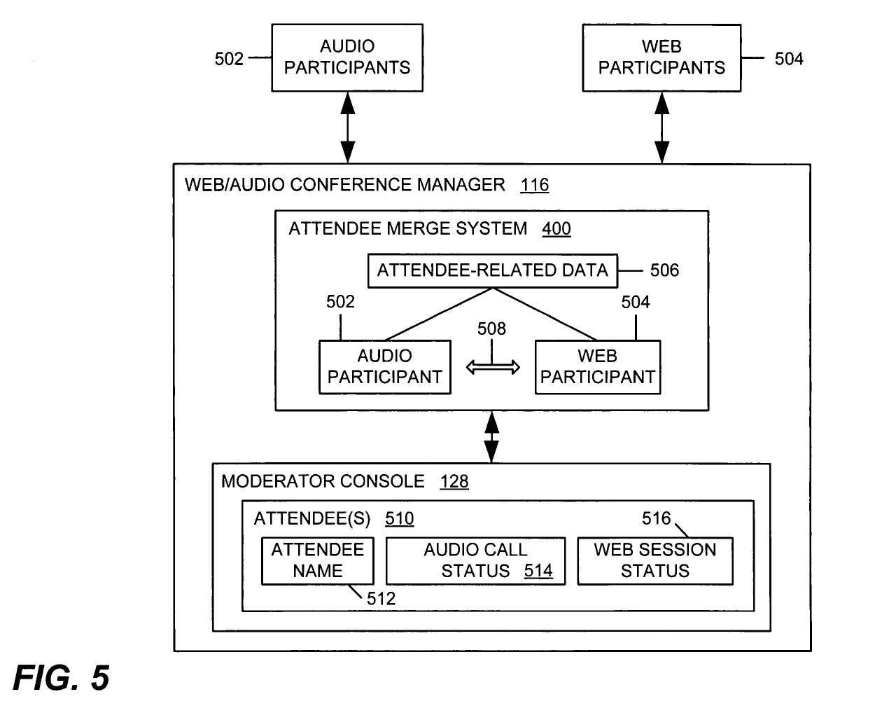

FIG. 5 illustrates an embodiment of AMS 400 in which the merging is automatically performed by matching the web attendee and the audio attendee based on common attendee-related data 506. As illustrated in FIG. 5, AMS 400 is configured to identify attendee-related data 506 associated with both an audio participant 502 and a web participant 504. In this manner, when a new attendee joins the conference, AMS 400 may use the common attendee-related data 506 to match an audio participant 502 with a web participant 504 (or vice versa) and merge the two “participants” into a single conference attendee 510 in moderator console 128.

It should be appreciated that the attendee-related data 506 may comprise various types of information, which may be obtained from audio participant 502 and web participant 504 in various ways. For example, any of the following or other types of information may be suitable for matching audio participant 502 and web participant 504: telephone number, name, email address, passcode, PIN, user account number, originating IP address, etc.

Attendee-related data 506 (for web participants 504 and/or audio participants 502) may be provided to conference platform 102 in various ways. With respect to web participants 504, in one embodiment, attendee-related data 506 is provided to conference platform 102 when web participant 504 registers with conference platform 104. In another embodiment, conference platform 102 may prompt web participant 504 to provide the information when joining the web portion of the conference. Attendee-related data 506 may also be embedded within the web link that conference platform 102 provides to invited attendees. When web participant 504 accesses the link to join the web portion of the conference, attendee-related data 506 may be passed to conference platform 102. Attendee-related data 506 may also be stored in a cookie associated with web client 106, which is accessed by conference platform 102 when web participant 504 joins the web portion of the conference.

Attendee-related data 506 associated with audio participants 502 may also be captured, obtained, received, etc. in various ways. For example, AMS 400 may use the attendee's telephone number to automatically match an audio participant 502 with a web participant 504. When an audio participant 502 joins the audio portion of the conference, AMS 400 may automatically determine the originating telephone number of audio participant 502 via an automatic number identification (ANI) service supported by a telephone service provider. Assuming that conference platform 102 has obtained telephone numbers for web participants 504 as described above, AMS 400 may search the telephone numbers for existing web participants 504 to determine if there is match for the telephone number associated with the new audio participant 504. If there is a match, AMS 400 may assume that web participant 504 and audio participant 502 correspond to the same individual. A similar scheme may be employed where the audio call is being implemented via, for example, the Internet. AMS 400 may use the IP address or other unique address associated with audio participant 502 to perform the match.

It should be appreciated that AMS 400 may determine attendee-related data 504 associated with audio participants 502 in various alternative ways. For example, audio participant 502 may be prompted to enter attendee-related data 506 via an interactive voice response (IVR) system. In this regard, an audio participant 502 may be prompted to enter a PIN, passcode, etc. that has been assigned by conference platform 102 and provided to attendees 104 invited to join the conference. AMS 400 may then use the entered information to match audio participant 502 with the corresponding web participant.

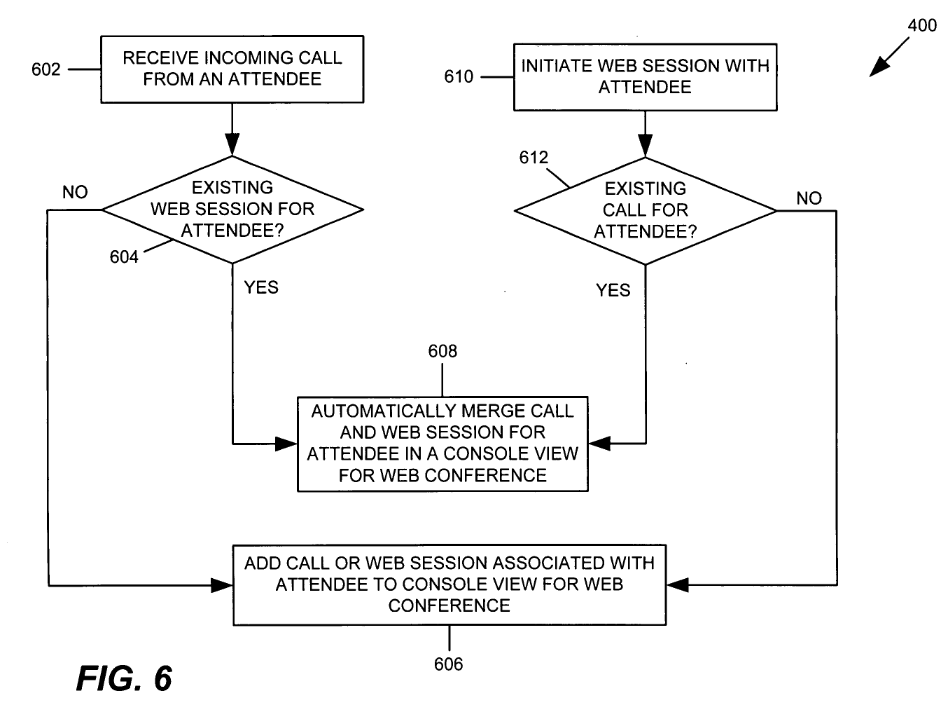

FIG. 6 illustrates the architecture, operation, and/or functionality of an embodiment of AMS 400. At block 602, AMS 400 receives an incoming call from an attendee. At decision block 604, AMS 400 determines whether there is an existing web session for the attendee based on attendee-related data 506. If AMS 400 determines that there is an existing web session for the attendee, at block 608, AMS 400 automatically merges the call and the web session for the attendee in the console view. If there is not an existing web session for the attendee, at block 606, AMS 400 adds the call associated with the attendee to the console view as a new audio participant 502.

At block 610, AMS 400 determines that there is a new web session for an attendee. At decision block 612, AMS 400 determines whether there is an existing audio call for that attendee. If AMS determines that there is an audio call for the attendee, at block 608, AMS 400 performs the merge. If there is not an existing audio call for the attendee, at block 606, AMS 400 adds the web session associated with the attendee to the console view as a new web participant 504.

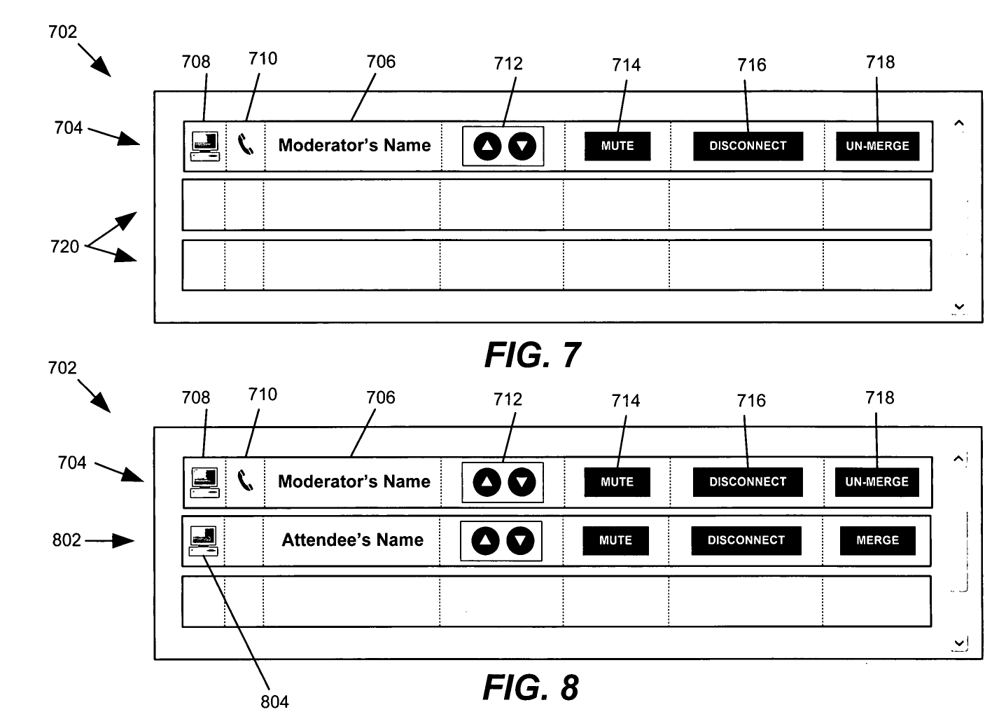

FIG. 7 illustrates an embodiment of a participants view 702 for moderator console 128 (or attendee console 126). As illustrated in FIG. 7, participants view 702 may comprise a list of attendees 104 participating in the conference. Although attendees 104 may be listed in any suitable fashion, the embodiment of FIG. 7 displays attendees 104 in a series of rows (704 and 720). Row 704 represents an active attendee corresponding to host/moderator 110. Rows 720 remain empty for additional attendees 104. For each active attendee, participants view 702 may display the name, role, etc. of the attendee in box 706. If the attendee's name is not known, box 706 may display a generic name for the attendee 104, such as “Web Participant 1,” “Audio-Participant 3,” etc. Participants view 702 may also include status icons, graphics, etc. for displaying whether the attendee 104 is a web participant (e.g., status indicator 708) or an audio participant (e.g., status indicator 710). Participants view 702 may further comprise various user interface controls associated with each attendee 104 (e.g., volume control 712, mute button 714, disconnect button 716, merge/un-merge button 718, etc.). As described in more detail below, merge/un-merge button 718 may be used to initiate a manual merge of a web participant 504 with an audio participant 502 (and vice versa).

As new attendees 104 join the conference, AMS 400 updates participants view 702 with the relevant information. FIG. 8 shows participants view 702 after a new web participant 504 joins the conference. The new web participant 504 is displayed in active row 802, which replaces one of the empty rows 720. The new web participant is also displayed with a web status indicator 804 to indicate that the attendee is a web participant 504, rather than an audio participant 502.

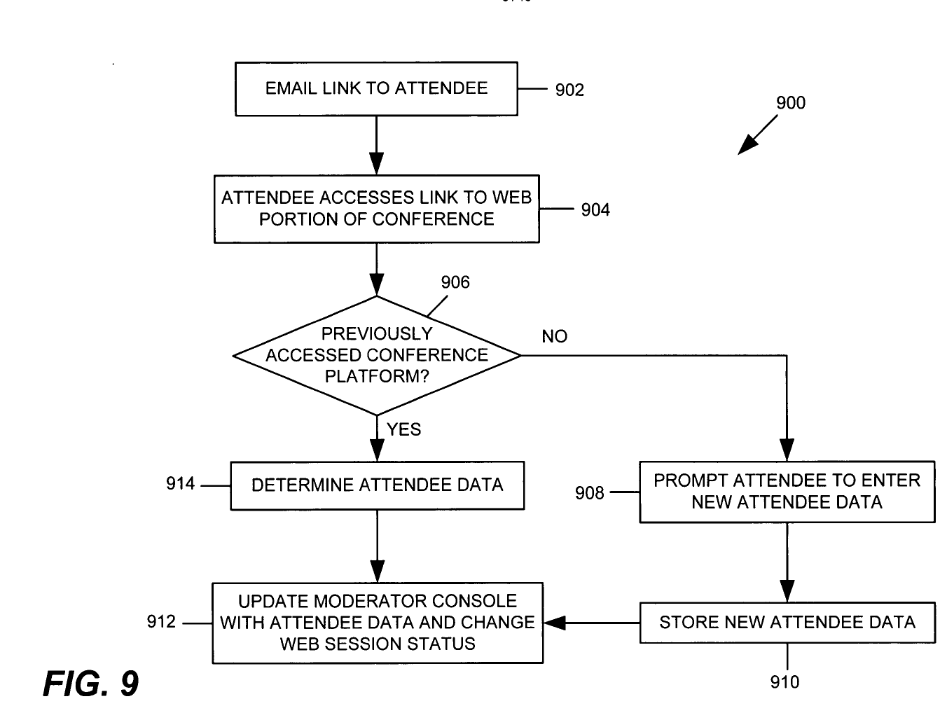

FIG. 9 is a flow chart 900 that illustrates a more detailed embodiment of how an attendee 104 may join the web portion of the conference. At block 902, attendee 104 is invited to the conference. As mentioned above, the notification may be received via an email, which may include a link to a URL for the web portion of the conference. At block 904, attendee 104 may access the link to the web portion of the conference. When attendee 104 accesses conference platform 102, AMS 400 may subsequently determine at block 906 whether attendee 104 has previously accessed conference platform 102. As mentioned above, conference platform 102 may employ a cookie mechanism (or any other means) to facilitate this process. If AMS 400 determines that attendee 104 has not previously accessed conference platform 400, at block 908, AMS 400 may prompt attendee 104 to enter various types of information (e.g., attendee-related data 506). At block 910, the entered information may be stored by conference platform 102. At block 912, AMS 400 may then update participants view 702 with appropriate identifying information (e.g., attendee's name) and display a web status indicator. However, if attendee 104 has previously accessed conference platform 102, AMS 400 may determine the appropriate attendee-related data 506 and update participants view 702 (block 912).

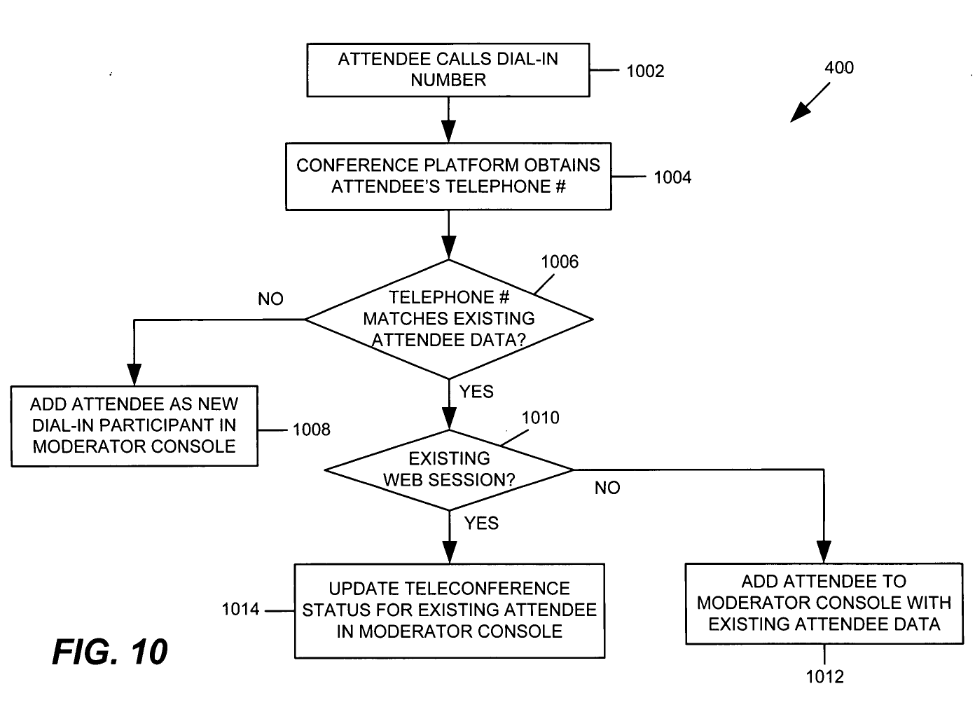

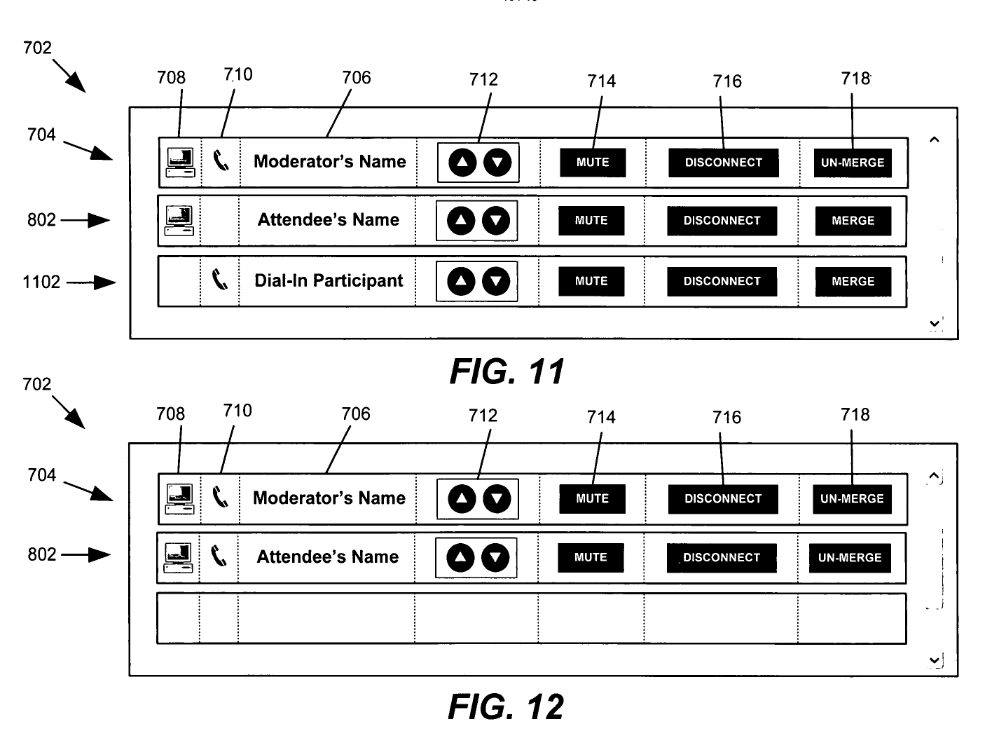

FIG. 10 illustrates another embodiment of AMS 400 for automatically merging a new audio participant 502 with an existing web participant 504 based on the audio participant's telephone number. At block 1002, AMS 400 determines that an attendee 104 is calling conference platform 102 to join the audio portion of the conference. At block 1004, AMS 400 obtains the attendee's telephone number. As mentioned above, the telephone number may be obtained via an ANI service. In alternative embodiments, the telephone number (or any other attendee-related data 506) may be received via an IVR system. At block 1006, AMS 400 determines whether the attendee's telephone number matches the stored telephone number associated with any of the existing web participants 504. If the attendee's telephone number does not yield a match, at block 1008, AMS 400 adds the new attendee to participants view 710 as an audio-only participant (e.g., “Dial-In. Participant”—FIG. 11).

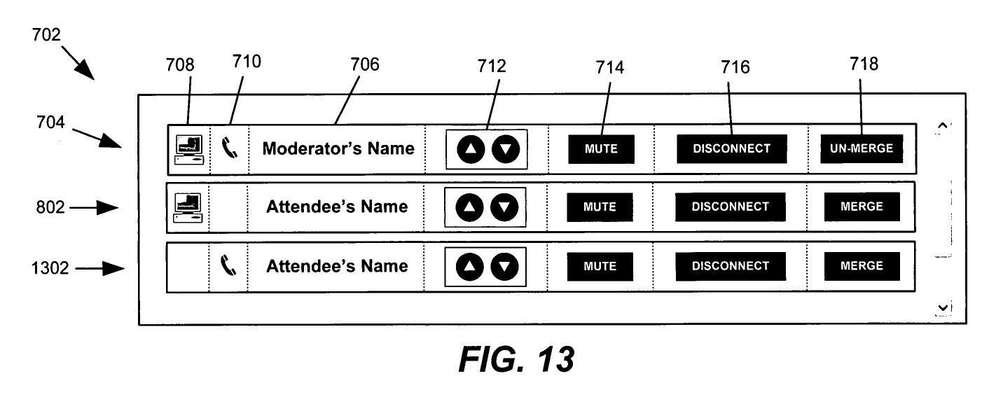

If the attendee's telephone number matches a stored telephone number, conference platform 102 determines the identity of the attendee. At block 1010, AMS 400 may further determine whether there is an existing web session for the attendee. If the attendee has an existing web session, at block 1014, AMS 400 updates participants view 702 to indicate that the existing attendee has now entered the audio portion of the conference, as well. As illustrated in FIG. 12, for example, AMS 400 merely updates record 802 with audio status indicator 710. If the attendee does not have an existing web session, however, at block 1012, AMS 400 adds the audio-only attendee to row 1302 (FIG. 13) of participants view 702. Because AMS 400 identifies the attendee based on the telephone number, the audio-only attendee may be displayed by name, rather than as a “Dial-In Participant.”

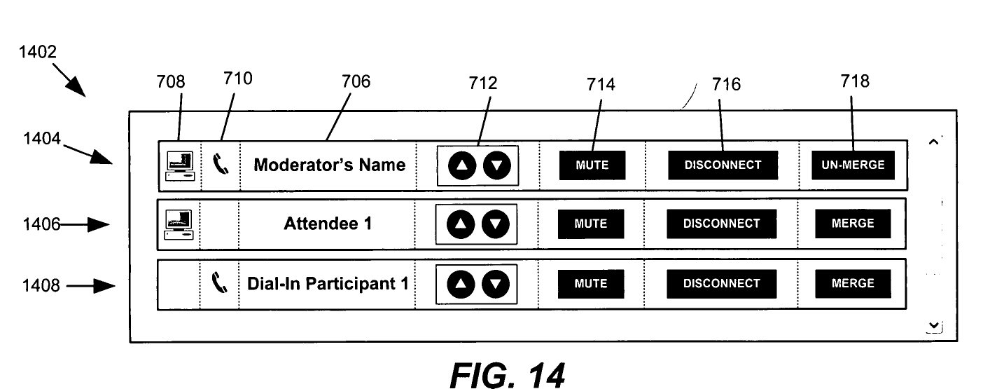

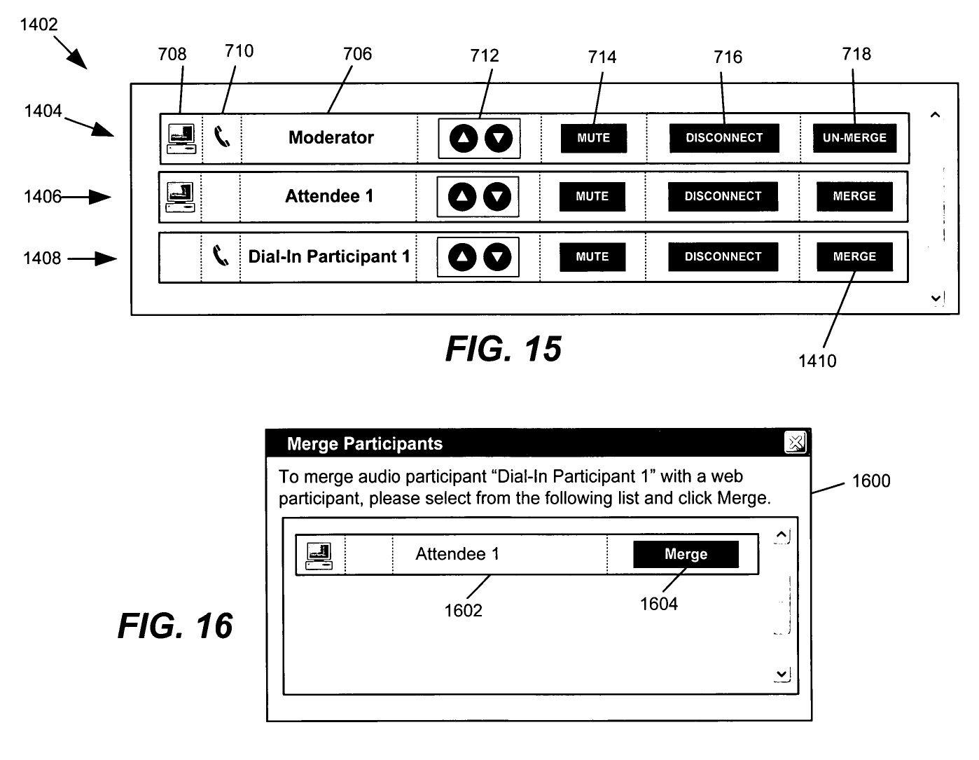

Another embodiment of a manual merge supported by AMS 400 will be described with reference to successive screen shots of another participants view 1402 (FIGS. 14-18). As illustrated in FIG. 14, participants view 1402 displays that three attendees 104 have joined the conference: (1) the host/moderator—row 1404; (2) a web-only participant (Attendee 1)—row 1406; and (3) an audio-only participant (Dial-In Participant 1)—row 1408. During the conference, it may become apparent to, for example, host/moderator 110 (row 1404) that Dial-In Participant 1 (row 1408) and Attendee 1 (row 1406) are the same individual. By way of example, participants view 1402 may support an auto-speaker functionality that automatically indicates when one of the attendees is speaking in the audio portion of the conference. In one embodiment, the audio status indicator 710 for the speaking attendee may be visually distinguished from the other indicators. FIG. 15 illustrates participants view 1402 in which Dial-In Participant 1 is speaking—note that audio status indicator 710 in row 1408 is greyed-out. As a result, host/moderator 110 may confirm that Dial-In Participant 1 is the same individual as Attendee 1.

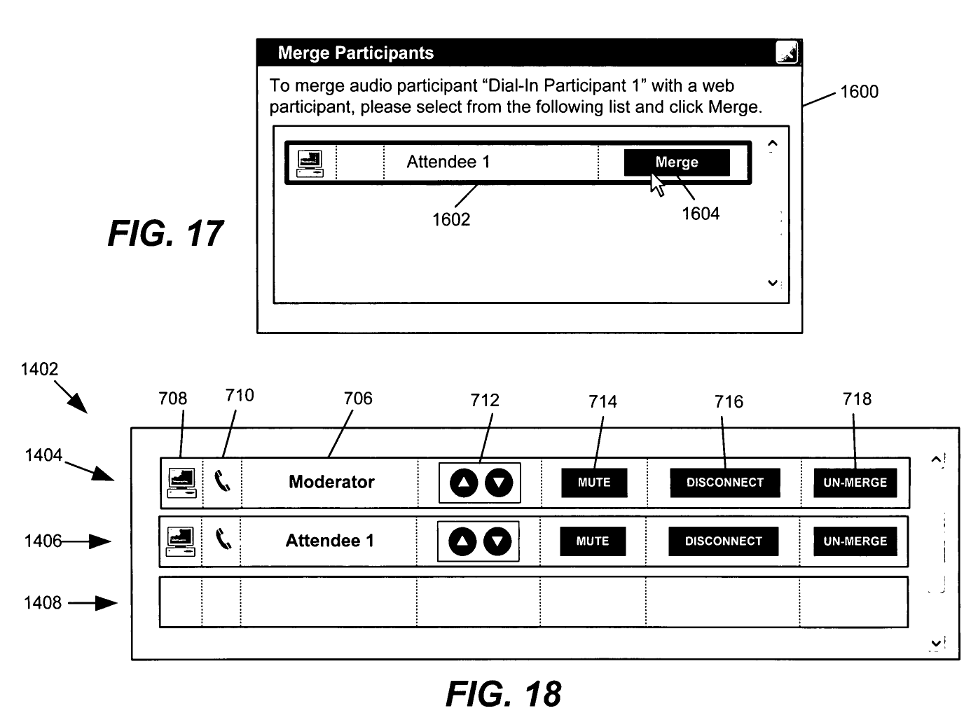

In order to initiate the manual merge of Dial-In Participant 1 and Attendee 1, in one embodiment, host/moderator 110 selects merge button 1410 in row 1408 associated with Dial-In Participant 1. In response to selection of merge button 1410, AMS 400 displays a Merge Participants window 1600 (FIG. 16), which lists all available web-only attendees in the conference. Host/moderator 110 may then select the appropriate web-only attendee from the list (FIG. 17) to which Dial-In Participant 1 is to be merged. In this example, host/moderator 110 selects Attendee 1. In response to the user selection, AMS 400 merges Attendee 1 and Dial-In Participant 1 into a single row—FIG. 18. It should be appreciated that the manual merge process may operate in the reverse order (i.e., where the web-only attendee is selected and the Merge Participants window 1600 lists all available audio-only attendees).

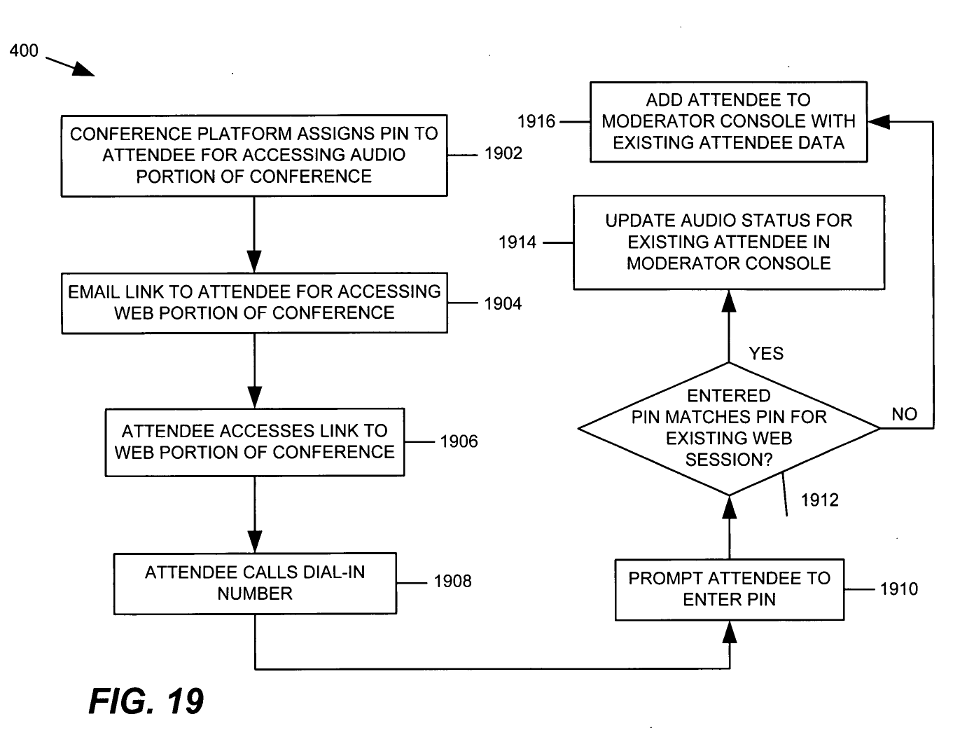

As mentioned above, AMS 400 may merge audio participants 502 with web participants 504 based on a unique PIN (or similar identifier) assigned by conference platform 102. One embodiment of a PIN-based merge is illustrated in the flow chart of FIG. 19. At block 1902, conference platform 102 assigns a unique PIN to an attendee 104 who is to be invited to join a teleconference. At block 1904, conference platform 102 notifies attendee 104 of the scheduled conference and provides the unique PIN. Conference platform 102 may also email attendee 104 with a link for accessing the web portion of the conference. At block 1906, attendee 104 accesses the link to join the web portion of the conference. At block 1908, attendee 104 calls the dial-in number for the scheduled conference. At block 1910, conference platform 102 prompts attendee 104 to enter the unique PIN identifying the attendee. At decision block 1912, AMS 400 determines whether the entered PIN matches the PIN for any of the existing web attendees. If the entered PIN matches an existing web attendee, at block 1914, AMS 400 updates the audio status indicator for the existing web attendee in moderator console 128. If the entered PIN does not match any existing web attendee, at block 1916, attendee 104 may be added to moderator console 128 as an audio-only participant. It should be appreciated, however, that subsequent web attendees may be matched against the unique PIN provided by the audio-only participant. If a match occurs, the subsequent web attendee may be merged with the audio-only participant.

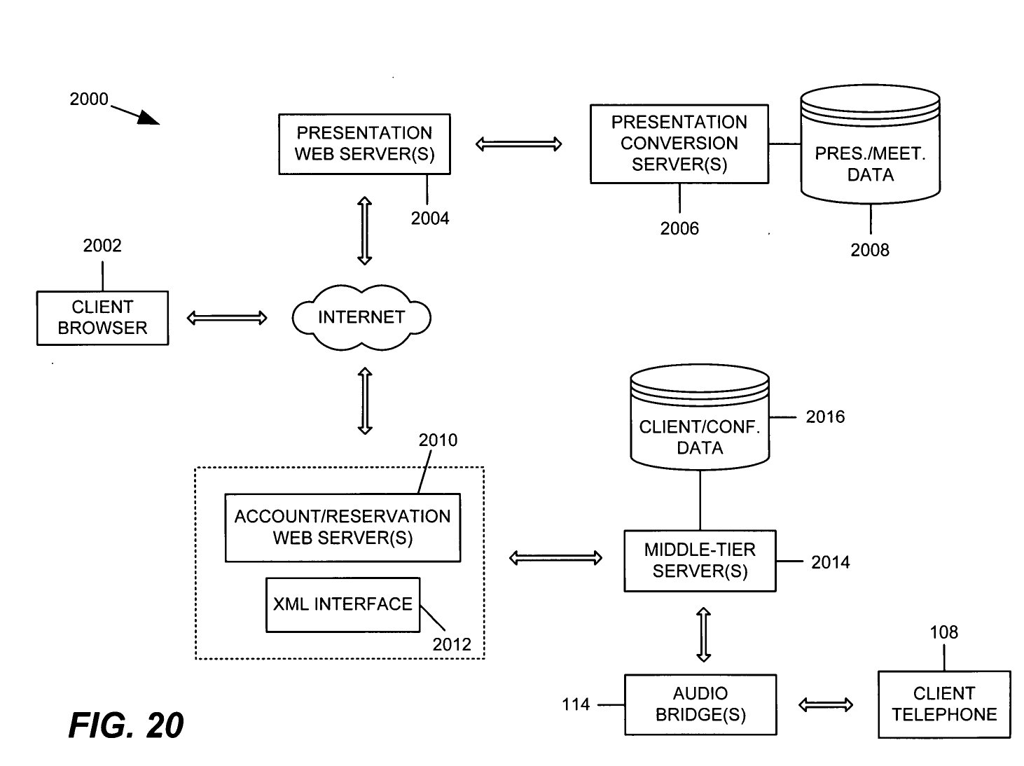

AMS 400 may be employed within any integrated web/audio conference system to manage participants in the conference. FIG. 20 illustrates another embodiment of an IWACS 2000 in which AMS 400 may be implemented. As illustrated in FIG. 20, web participants 504 may access IWACS 2000 via any client browser 2002. Client browser 2002 enables web participants 504 and host/moderator 110 to communicate with presentation web server(s) 2004, account/reservation web server(s) 2010, and XML interface 2012. Account/reservation web server(s) 2010 control user access to the platform, and XML interface 2012 handles the bulk of the message traffic within IWACS 2000.

Presentation web server(s) 2004 provide the functionality for enabling host/moderator 110 to upload presentation materials. IWACS 2000 may employ conversion server(s) 2006 to convert the presentation materials into a format suitable for presentation via moderator console 128 and/or attendee console 126. In one embodiment, IWACS 2000 converts the uploaded materials into a format compatible with a multimedia plug-in, such Macromedia Flash®. The converted presentation materials may be stored in presentation/meeting data store 2008.

Audio participants 502 join the conference via telephones 108 that communicate with audio bridge(s) 114. IWACS 2000 may also employ middle-tier server(s) 2014 (and client/conference data store 2016) to promote scalability, redundancy, and to enhance message handling, traffic, user validation, etc.

One of ordinary skill in the art will appreciate that the attendee merge system may be implemented in software, hardware, firmware, or a combination thereof. Accordingly, in one embodiment, the attendee merge system is implemented in software or firmware that is stored in a memory and that is executed by a suitable instruction execution system. In hardware embodiments, the attendee merge system may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be further appreciated that the process descriptions or functional blocks in FIGS. 1-20 represent modules, segments, or portions of logic, code, etc. which include one or more executable instructions for implementing specific logical functions or steps in the process. It should be further appreciated that any logical functions may be executed out of order from that shown or discussed, including substantially concurrently or in reverse order, depending on the functionality involved, as would be understood by those reasonably skilled in the art.

Furthermore, the attendee merge system may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Although this disclosure describes various embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A method for managing participants in an integrated web/audio conference system, the method comprising merging one of an audio participant and a web participant of an integrated web/audio conference with the other of the audio participant and the web participant in a console view of the integrated web/audio conference.

2. The method of claim 1, wherein the merging one of the audio participant and the web participant with the other of the audio participant and the web participant in the console view of the integrated web/audio conference comprises matching the audio participant's telephone number with attendee-related data associated with the web participant.

3. The method of claim 2, wherein the matching the audio participant's telephone number with attendee-related data associated with the web participant comprises automatically determining the audio participant's telephone number from an incoming call.

4. The method of claim 1, wherein the merging one of the audio participant and the web participant with the other of the audio participant and the web participant in the console view of the integrated web/audio conference comprises:
receiving an incoming call from the audio participant;
automatically determining the audio participant's telephone number; and
associating the audio participant with the web participant based on the audio participant's telephone number.

5. The method of claim 1, wherein the merging one of the audio participant and the web participant with the other of the audio participant and the web participant in the console view of the integrated web/audio conference comprises:
selecting, in the console view, the one of the audio participant and the web participant to be merged;
providing a list of participants capable of being merged with the selected one of the audio participant and the web participant;
selecting, in the console view, the other of the audio participant and the web participant with which the one of the audio participant and the web participant is to be merged.

6. The method of claim 5, further comprising unmerging the one of the audio participant and the web participant with the other of the audio participant and the web participant via the console view.

7. The method of claim 1, wherein the merging one of the audio participant and the web participant with the other of the audio participant and the web participant in the console view of the integrated web/audio conference comprises identifying the web participant when the audio participant dials into the integrated web/audio conference.

8. The method of claim 7, wherein the web participant is identified based on the audio participant's telephone number.

9. The method of claim 1, wherein the merging one of the audio participant and the web participant with the other of the audio participant and the web participant in the console view of the integrated web/audio conference comprises identifying the web participant based on a PIN assigned to the web participant and provided by the audio participant.

10. The method of claim 1, wherein the merging one of the audio participant and the web participant with the other of the audio participant and the web participant in the console view of the integrated web/audio conference comprises:
prompting the audio participant to enter a PIN;
receiving an entered PIN from the audio participant; and
matching the entered PIN to an assigned PIN associated with the web participant.

11. A web conference system comprising:
a conference manager that monitors audio and web attendees participating in an integrated audio/web conference;
a console for displaying the audio and web attendees participating in the integrated audio/web conference; and
an attendee merge functionality associated with the console, the attendee merge functionality comprising logic configured to merge one of the audio participants with one of the web participants in the console.

12. The web conference system of claim 11, wherein the console is displayed via a web session associated with one of the web participants.

13. The web conference system of claim 11, wherein the console is displayed via a web session associated with a moderator of the integrated audio/web conference.

14. The web conference system of claim 11, wherein the attendee merge functionality identifies the one of the web participants with which the one of the audio participants is being merged based on the one of the audio participant's telephone number.

15. The web conference system of claim 11, wherein the attendee merge functionality associates the one of the web participants with the one of the audio participants based on a PIN entered by the one of the audio participants.

16. The web conference system of claim 11, wherein the attendee merge functionality comprises:
logic configured to determine a telephone number associated with the one of the audio participants; and
logic configured to identify the one of the web participants to which the one of the audio participants is to be merged based on the telephone number.

17. The web conference system of claim 11, wherein the attendee merge functionality comprises logic configured to automatically merge the one of the audio participants with the one of the web participants.

18. The web conference system of claim 11, wherein the attendee merge functionality comprises logic configured to enable one of the web participants to select the audio participant and the web participant that are to be merged.

19. The web conference system of claim 18, wherein the attendee merge functionality supports an un-merge feature.

20. An integrated web/audio system comprising:
console means for displaying audio and web attendees participating in an integrated audio/web conference; and
means for merging one of the audio attendees with one of the web attendees in the console means.
